(19) United States
(12) Patent Application Publication
(10) Pub. No.: US 2025/0030241 A1
(43) Pub. Date: Jan. 23, 2025

(54) FINITE CONTROL SET MODEL PREDICTION CONTROL METHOD OF LLCL BATTERY ENERGY STORAGE CONVERTER

(71) Applicant: SHANGHAI MARITIME UNIVERSITY, Shanghai (CN)

(72) Inventors: Ning GAO, Shanghai (CN); Cheng YANG, Shanghai (CN); Hao CHEN, Shanghai (CN); Bo LI, Shanghai (CN); Weimin WU, Shanghai (CN)

(21) Appl. No.: 18/705,874

(22) PCT Filed: Jul. 18, 2023
(86) PCT No.: PCT/CN2023/107933

§ 371 Date: Apr. 29, 2024

(30) Foreign Application Priority Data
Oct. 17, 2022 (CN) 202211264741.1

(51) Int. Cl. H02J 3/01; G05B 13/04; H02J 3/32; H02M 1/15

(52) U.S. Cl. CPC H02J 3/01; G05B 13/048; H02J 3/32; H02M 1/15; H02J 2203/20

(57) ABSTRACT

The present disclosure relates to a finite control set model predictive control method of an LLCL battery energy storage converter, wherein the method uses a finite control set model predictive control method to control an energy storage converter based on an LLCL filter, establishes and discretizes a state space mathematical model of the LLCL battery energy storage converter to obtain a discrete model, converts reference values of a current at a grid side into reference values of a current at a converter side and a capacitor voltage based on a phasor method at the same time, defines a cost function, compares an output result of a prediction model with the reference value, selects an optimal voltage vector and selects a most appropriate switching state to work.

### CROSS REFERENCE TO RELATED APPLICATION

This patent application is a national stage of International Application No. PCT/CN2023/107933, filed on Jul. 18, 2023, which claims the benefit and priority of Chinese Patent Application No. 202211264741.1 filed to China National Intellectual Property Administration on Oct. 17, 2022, entitled as “FINITE CONTROL SET MODEL PREDICTION CONTROL METHOD OF LLCL BATTERY ENERGY STORAGE CONVERTER”. Both of the aforementioned applications are incorporated by reference herein in their entireties as part of the present application.

### TECHNICAL FIELD

The present disclosure relates to the field of new energy generation and electric energy storage, in particular to a finite control set model predictive control method of an LLCL battery energy storage converter.

### BACKGROUND

A battery energy storage converter is a key device in a battery energy storage system, which can convert direct current energy of a battery into standard alternating current energy and merge it into the grid, and realize bidirectional energy flow. A finite control set model predictive control (FCS-MPC) algorithm is a typical nonlinear control algorithm, which has been widely used in industry. The control method is different from the traditional PI control method. The control method predicts grid-connected current in a next period based on the model, and then selects an optimal control value according to the prediction result, which has clear physical meaning and superior performance.

Compared with a traditional filter, an LLCL filter has a good filtering effect and good dynamic performance, because an inductor is inserted in a capacitor branch loop of the LLCL filter to form a series resonant circuit at a switching frequency. In addition, the LLCL filter can effectively attenuate a current ripple component at the switching frequency, thus reducing total inductance, reducing volume of passive devices and helping to reduce the total cost of the battery energy storage converter.

In the prior art, the finite control set model predictive control algorithm is mostly applied to the LCL energy storage converter. For example, China patent application CN201910853161.8 discloses a finite control set model predictive control method of the LCL energy storage converter. The method combines state variable estimation with delay compensation, estimates a current at a converter side, capacitor voltage and grid current by sampling the grid current, and corrects an error between the sampled grid current and the estimated grid current by a correction matrix, so as to reduce influence caused by model mismatch and parameter drift. The estimated state variables are then input into a finite control set model predictive control algorithm with a delay compensation, so as to improve system performance and finally realize control of the LCL energy storage converter. The above disclosure can reduce the number of sensors, reduce the cost and improve the reliability of the system. Combined with a delay compensation algorithm, the disclosure eliminates influence of calculation delay on the system performance, and improves the quality of grid-connected current. However, the traditional LCL grid-connected filter has high cost and unsatisfactory filtering effect, which leads to low quality of grid-connected current and poor control performance and reliability of the system.

### SUMMARY

The objective of the present disclosure is to provide a finite control set model predictive control method of an LLCL type battery energy storage converter, which overcomes the defects in the prior art. In the present disclosure, the LLCL filter is applied to the energy storage converter, and combined with FCS-MPC control algorithm, to take advantage of the LLCL filter, so that the quality of the grid-connected power can be improved, and the optimal control of the energy storage converter can be realized.

The objective of the present disclosure can be achieved by the following technical solution.

A finite control set model predictive control method of the LLCL battery energy storage converter includes: collecting electrical physical quantities by using sensors, wherein the electrical physical quantities include a current at a grid side, a current at a converter side, a grid voltage and a capacitor voltage at current time; building a state space mathematical model of an LLCL filter based on the electrical physical quantities; setting a sampling period and discretizing the state space mathematical model of the LLCL filter to obtain a discrete model; deriving reference values of the current at the converter side and reference values of capacitor voltage in a k-th sampling period by using given values of the current at the grid side in the k-th sampling period; based on the reference values of the current at the converter side and the reference values of capacitor voltage in the k-th sampling period, predicting reference values at time k+1 according to the discrete model; defining a cost function to quantitatively evaluate control performance of each voltage vector in a finite set; calculating the cost function corresponding to each voltage vector based on the reference values at time k+1, and selecting an optimal output voltage vector which minimizes a result of the cost function; based on a corresponding relationship between each voltage vector and a circuit switch, sending the optimal output voltage vector to control an appropriate circuit switch state for operating.

Further, building the state space mathematical model of the LLCL filter includes: establishing a two-phase static coordinate system which is an α-β coordinate system; with current i₁ flowing through an inductor L₁, current i₂ flowing through an inductor L₂ and a voltage u_{c} of a capacitor C as state space variables, based on an overall topological structure of the battery energy storage converter, establishing basic equations of each loop under an α coordinate axis:

$${L}_{1} \frac{{di}_{1 α}}{dt} = {u}_{i α} - {u}_{m α} \qquad ( 1 )$$

$${L}_{2} \frac{{di}_{2 α}}{dt} = {u}_{m α} - {u}_{g α} \qquad ( 2 )$$

$${i}_{3 α} = {i}_{1 α} - {i}_{2 α} \qquad ( 3 )$$

$${u}_{m α} = {u}_{c α} + {L}_{3} \frac{{di}_{3 α}}{dt} \qquad ( 4 )$$

$$C \frac{{du}_{c α}}{dt} = {i}_{1} - {i}_{2} \qquad ( 5 )$$

where for the α coordinate axis, i_{1α} is an instantaneous value of the current at the converter side, i_{2α} is a value of the current at the grid side, i_{3α} is a value of the current flowing through the capacitor, u_{iα} is a converter output voltage, u_{mα} is a value of a voltage at a coupling point of an LC branch, u_{gα} is a value of a voltage at the grid side, u_{cα} is a value of the capacitor voltage, C is a capacitor value, L₁ is a first inductance value, and L₂ is a second inductance value; deriving the equations of an α component as shown in equation (6) by substituting equations (3) and (4) into equations (1) and (2) and by variable substitution,:

$$\{ \begin{matrix}\frac{{di}_{1 α}}{dt} = \frac{{L}_{2} + {L}_{3}}{{L}_{1} {L}_{2} + {L}_{1} {L}_{3} + {L}_{2} {L}_{3}} {u}_{i α} - \frac{{L}_{2}}{{L}_{1} {L}_{2} + {L}_{1} {L}_{3} + {L}_{2} {L}_{3}} {u}_{c α} - \frac{L}{{L}_{1} {L}_{2} + {L}_{1} {L}_{3} + {L}_{2} {L}_{3}} {u}_{g α} \\ \frac{{di}_{2 α}}{dt} = \frac{{L}_{3}}{{L}_{1} {L}_{2} + {L}_{1} {L}_{3} + {L}_{2} {L}_{3}} {u}_{i α} + \frac{{L}_{1}}{{L}_{1} {L}_{2} + {L}_{1} {L}_{3} + {L}_{2} {L}_{3}} {u}_{c α} - \frac{{L}_{1} + {L}_{3}}{{L}_{1} {L}_{2} + {L}_{1} {L}_{3} + {L}_{2} {L}_{3}} {u}_{g α} \\ \frac{{du}_{c α}}{dt} = \frac{1}{C} ( {i}_{1 α} - {i}_{2 α} )\end{matrix} \qquad ( 6 )$$

where L₃ is a third inductance value; obtaining an expression of the state space mathematical model of the LLCL filter on the α axis:

$$\frac{{dx}_{α}}{dt} = {Ax}_{α} + {Bu}_{i α} + {B}_{g} {u}_{g α} ;$$

where x_{α}=[i_{1α} i_{2α} u_{cα}]^{T} is a state space vector on the α axis, and expressions of matrix A, matrix B and matrix B_{g} are respectively:

$$A = [ \begin{matrix}0 & 0 & - {L}_{2} / {L}_{\sum } \\ 0 & 0 & {L}_{1} / {L}_{\sum } \\ 1 / C & - 1 / C & 0\end{matrix} ]$$

$$B = {[ \begin{matrix}( {L}_{2} + {L}_{3} ) / {L}_{\sum } & {L}_{3} / {L}_{\sum } & 0\end{matrix} ]}^{T}$$

$${B}_{g} = {[ \begin{matrix}- {L}_{3} / {L}_{\sum } & - ( {L}_{1} + {L}_{3} ) / {L}_{\sum } & 0\end{matrix} ]}^{T}$$

where L_{Σ}=L₁L₂+L₁L₃+L₂L₃

Further, the α axis and the β axis of the α-β coordinate system are symmetric, and an expression of the state space mathematical model of the LLCL filter on the β axis is obtained by replacing α with β:

$$\frac{{dx}_{β}}{dt} = {Ax}_{β} + {Bu}_{i β} + {B}_{g} {u}_{g β} ;$$

where x_{β}=[i_{1β} i_{2β} u_{cβ}]^{T} is an state space vector on the β axis, and for the β coordinate axis, i_{1β} is an instantaneous value of the current at the converter side, i_{2β} is a value of the current at the grid side, u_{1β} is a converter output voltage, u_{gβ} is a value of the voltage at the grid side, and u_{cβ} is a value of capacitor voltage; the state space mathematical model of the LLCL filter in the α-β coordinate system is obtained:

$$\{ \begin{matrix}\frac{{dx}_{α}}{dt} = {Ax}_{α} + {Bu}_{i α} + {B}_{g} {u}_{g α} \\ \frac{{dx}_{β}}{dt} = {Ax}_{β} + {Bu}_{i β} + {B}_{g} {u}_{g β}\end{matrix} \qquad ( 7 )$$

Further, the sampling period is a battery energy storage switching period, the sampling period is set as Tₛ, the expression (7) of the state space mathematical model of the LLCL filter is discretized by using a zero-order holder method, and an expression of the discrete model of the LLCL filter is obtained:

$$\{ \begin{matrix}{x}_{α} ( k + 1 ) = {A}_{d} {x}_{α} ( k ) + {B}_{d} {u}_{i α} ( k ) + {B}_{gd} {u}_{g α} ( k ) \\ {x}_{β} ( k + 1 ) = {A}_{d} {x}_{β} ( k ) + {B}_{d} {u}_{i β} ( k ) + {B}_{gd} {u}_{g β} ( k )\end{matrix} \qquad ( 8 )$$

where k indicates a periodic time, and detailed expressions of a system matrix A_{d} and input matrices B_{d} and B_{gd} are:

$${A}_{d} = {e}^{{AT}_{s}} = [ \begin{matrix}\frac{{L}_{1} + {L}_{2} cos ( {ω}_{res} {T}_{s} )}{{L}_{1} + {L}_{2}} & \frac{{L}_{2} ( 1 - cos ( {ω}_{res} {T}_{s} )}{{L}_{1} + {L}_{2}} & - \frac{{L}_{2} sin ( {ω}_{res} {T}_{s} )}{{ω}_{res} {L}_{\sum }} \\ \frac{{L}_{1} ( 1 - cos ( {ω}_{res} {T}_{s} )}{{L}_{1} + {L}_{2}} & \frac{{L}_{2} + {L}_{1} cos ( {ω}_{res} {T}_{s} )}{{L}_{1} + {L}_{2}} & \frac{{L}_{1} sin ( {ω}_{res} {T}_{s} )}{{ω}_{res} {L}_{\sum }} \\ \frac{sin ( {ω}_{res} {T}_{s} )}{{ω}_{res} C} & - \frac{sin ( {ω}_{res} {T}_{s} )}{{ω}_{res} C} & cos ( {ω}_{res} {T}_{s} )\end{matrix} ] \qquad ( 9 )$$

$${B}_{d} = {\int }_{0}^{{T}_{s}} {e}^{A τ} Bd τ = [ \begin{matrix}\frac{{T}_{s}}{{L}_{1} + {L}_{2}} + \frac{{L}_{2}^{2} sin ( {ω}_{res} {T}_{s} )}{{L}_{\sum } ( {L}_{1} + {L}_{2} ) {ω}_{res}} \\ \frac{{T}_{s}}{{L}_{1} + {T}_{2}} - \frac{{L}_{1} {L}_{2} sin ( {ω}_{res} {T}_{s} )}{{L}_{\sum } ( {L}_{1} + {L}_{2} ) {ω}_{res}} \\ \frac{{L}_{2} ( 1 - cos ( {ω}_{res} {T}_{s} ) )}{( {L}_{1} + {L}_{2} )}\end{matrix} ] \qquad ( 10 )$$

$${B}_{gd} = {\int }_{0}^{{T}_{s}} {e}^{A τ} {B}_{g} d τ = [ \begin{matrix}- \frac{{T}_{s}}{{L}_{1} + {L}_{2}} + \frac{{L}_{1} {L}_{2} sin ( {ω}_{res} {T}_{s} )}{{L}_{\sum } ( {L}_{1} + {L}_{2} ) {ω}_{res}} \\ - \frac{{T}_{s}}{{L}_{1} + {T}_{2}} - \frac{{L}_{1}^{2} sin ( {ω}_{res} {T}_{s} )}{{L}_{\sum } ( {L}_{1} + {L}_{2} ) {ω}_{res}} \\ \frac{{L}_{1} ( 1 - cos ( {ω}_{res} {T}_{s} ) )}{( {L}_{1} + {L}_{2} )}\end{matrix} ] \qquad ( 11 )$$

where ωᵣₑₛ is an equivalent resonant angular frequency of the LLCL filter, and expression thereof is:

$${ω}_{res} = \sqrt{\frac{{L}_{1} + {L}_{2}}{{L}_{\sum } C}} . \qquad ( 12 )$$

Further, based on a phasor method, deriving the reference values i_{α1}*(k) and i_{β1}*(k) of the current at the converter side and the reference values u_{cα}*(k) and u_{cβ}*(k) of the capacitor voltage in the k-th sampling period by using the given values i_{2α}*(k) and i_{2β}*(k) of the current at the grid side in the k-th sampling period, which are respectively expressed as;

$$[ \begin{matrix}{u}_{c α}^{*} ( k ) \\ {u}_{c β}^{*} ( k )\end{matrix} ] = \frac{1}{1 - {ω}^{2} {L}_{3} C} ( [ \begin{matrix}{u}_{g α} ( k ) \\ {u}_{g β} ( k )\end{matrix} ] + ω {L}_{2} [ \begin{matrix}- {i}_{2 α}^{*} ( k ) \\ {i}_{2 β}^{*} ( k )\end{matrix} ] )$$

$$[ \begin{matrix}{i}_{1 α}^{*} ( k ) \\ {i}_{1 β}^{*} ( k )\end{matrix} ] = ( 1 - \frac{{ω}^{2} {L}_{2} C}{1 - {ω}^{2} {L}_{3} C} ) [ \begin{matrix}{i}_{2 α}^{*} ( k ) \\ {i}_{2 β}^{*} ( k )\end{matrix} ]$$

where ω is an angular frequency of the grid.

Further, the reference values of the current at the grid side, the reference values of capacitor voltage and the reference values of the current at the converter side in the (k+1)-th sampling period are obtained based on a Lagrange n-order extrapolation method, and expressions thereof are:

$$\{ \begin{matrix}{i}_{1 α}^{*} ( k + 1 ) = 3 {i}_{1 α}^{*} ( k ) - 3 {i}_{1 a}^{*} ( k - 1 ) + {i}_{1 α}^{*} ( k - 2 ) \\ {i}_{1 β}^{*} ( k + 1 ) = 3 {i}_{1 β}^{*} ( k ) - 3 {i}_{1 β}^{*} ( k - 1 ) + {i}_{1 β}^{*} ( k - 2 ) \\ {i}_{2 α}^{*} ( k + 1 ) = 3 {i}_{2 α}^{*} ( k ) - 3 {i}_{2 a}^{*} ( k - 1 ) + {i}_{2 α}^{*} ( k - 2 ) \\ {i}_{2 β}^{*} ( k + 1 ) = 3 {i}_{2 β}^{*} ( k ) - 3 {i}_{2 β}^{*} ( k - 1 ) + {i}_{2 β}^{*} ( k - 2 ) \\ {u}_{c α}^{*} ( k + 1 ) = 3 {u}_{c α}^{*} ( k ) - 3 {u}_{c α}^{*} ( k - 1 ) + {u}_{c α}^{*} ( k - 2 ) \\ {i}_{c β}^{*} ( k + 1 ) = 3 {u}_{c β}^{*} ( k ) - 3 {u}_{c β}^{*} ( k - 1 ) + {u}_{c β}^{*} ( k - 2 )\end{matrix}$$

where i_{1α}*(k+1) and i_{1β}*(k+1) indicate reference values of the current at the converter side at time k+1, i_{2α}*(k+1) and i_{2β}*(k+1) indicate reference values of the current at the grid side at time k+1, u_{cα}*(k+1) and u_{cβ}*(k+1) indicate reference values of capacitor voltage at time k+1.

Further, the cost function is defined as:

$$J = {ε}_{i 1}^{2} ( k + 1 ) + {λ}_{i 2} {ε}_{i 2}^{2} ( k + 1 ) + {λ}_{uc} {ε}_{uc}^{2} ( k + 1 )$$

where λᵢ₂ and λ_{uc} indicate priorities of modulation weight factor control, εᵢ₁ indicates an error between the reference value and the predicted value of the current at the converter side at the next moment, εᵢ₂ indicates an error between the reference value and the predicted value of current at the grid side at next time, and ε_{uc} indicates an error between the reference value and the predicted value of capacitor voltage at next time, and expressions thereof are:

$$\{ \begin{matrix}{ε}_{i 1}^{2} ( k + 1 ) = {( {i}_{1 α}^{*} ( k + 1 ) - {i}_{1 α} ( k + 1 ) )}^{2} + {( {i}_{1 β}^{*} ( k + 1 ) - {i}_{1 β} ( k + 1 ) )}^{2} \\ {ε}_{i 2}^{2} ( k + 1 ) = {( {i}_{2 α}^{*} ( k + 1 ) - {i}_{2 α} ( k + 1 ) )}^{2} + {( {i}_{2 β}^{*} ( k + 1 ) - {i}_{2 β} ( k + 1 ) )}^{2} \\ {ε}_{uc}^{2} ( k + 1 ) = {( {u}_{u α}^{*} ( k + 1 ) - {u}_{c α} ( k + 1 ) )}^{2} + {( {u}_{c β}^{*} ( k + 1 ) - {u}_{c β} ( k + 1 ) )}^{2}\end{matrix}$$

where i_{1α}*(k+1) and i_{1β}*(k+1) indicate reference values of the current at the converter side at time k+1, i_{2α}*(k+1) and i_{2β}*(k+1) indicate reference values of the current at the grid side at time k+1, u_{cα}*(k+1) and u_{cβ}*(k+1) indicate reference values of capacitor voltage at time k+1; i_{1α} (k+1) and i_{1β} (k+1) indicate predicted values of the current at the converter side at time k+1, i_{2α} (k+1) and i_{2β} (k+1) indicate predicted values of the current at the grid side at time k+1, and u_{cα} (k+1) and u_{cβ} (k+1) indicate predicted values of capacitor voltage at time k+1.

Further, voltage vectors u_{α} (k) and u_{β} (k) in the finite set of the battery energy storage converter are numbered 0-7, respectively, and the voltage vectors are substituted into the discrete model of the LLCL filter to obtain a predicted value at time k+1.

Further, the predicted value at the time k+1 is substituted into the cost function to obtain a calculation result of the cost function corresponding to each voltage vector; expressions of the cost functions corresponding to the voltage vectors numbered 0-7 in the finite set are defined as J₀-J₇; J₁ and J₄ are calculated, if J₁<J₄, J₀, J₂ and J₆ are further calculated, J₀, J₂, J₆ and J₁ are compared to select a voltage vector that minimizes a result of the cost function as an optimal vector; if J₁>J₄, J₀, J₃ and J₅ are further calculated, J₀, J₃, J₅ and J₄ are compared to select a voltage vector that minimizes a result of the cost function as an optimal vector.

Further, if J₀ is a minimum cost function, an optimal vector is selected between the voltage vector 0 and the voltage vector 7 according to a principle of minimum number of switches.

Compared with the prior art, the present disclosure has the following beneficial effects.

In the present disclosure, the LLCL filter is used as a power converter system and is connected to the grid. The LLCL filter-based energy storage converter is controlled by using a finite control set model predictive control method. By deriving the mathematical model of the LLCL filter and further obtaining the specific expression of the discrete model, the reference value conversion relationship and the recursive expression are obtained. After the LLCL filter is applied and the algorithm of the present disclosure is introduced, the performance of the battery energy storage converter can be improved, so that the battery energy storage converter can effectively suppress harmonics, reduce the total inductance and improve the quality of grid-connected current, thus improving the quality of grid-connected power and the control performance and reliability of the system.

### BRIEF DESCRIPTION OF THE DRAWINGS

In order to explain technical solutions in the embodiments of the present disclosure or in the prior art more clearly, the drawings required in the embodiments will be briefly described hereinafter. Apparently, the drawings described below are only some embodiments of the present disclosure. For those skilled in the art, other drawings can be obtained from these drawings without creative efforts

FIG. 1 is an overall control block diagram of a system corresponding to the present disclosure.

FIG. 2 is a schematic diagram of variable definitions of an LLCL energy storage converter according to an embodiment of the present disclosure.

FIG. 3 is a simplified LLCL filtering circuit diagram according to an embodiment of the present disclosure.

FIG. 4 is a complete control set of a battery energy storage converter according to an embodiment of the present disclosure.

FIG. 5 is a simulation result diagram of grid-connected current and grid- connected voltage according to an embodiment of the present disclosure.

### DETAILED DESCRIPTION OF THE EMBODIMENTS

The implementations of the present disclosure will be described by specific embodiments hereinafter. Those skilled in the art can easily understand other advantages and effects of the present disclosure from the contents disclosed in this specification. In order to better understand the objective, structure and function of the present disclosure, an embedded wind wheel structure of a wind turbine according to the present disclosure will be further described in detail with reference to the accompanying drawings.

The present disclosure mainly aims at the application of a battery energy storage converter in the field related to a power automation device, in particular to a finite control set model predictive control method of an LLCL battery energy storage converter, and the finite control set model predictive control method is abbreviated as FCS-MPC.

This embodiment provides a finite control set model predictive control method of an LLCL battery energy storage converter, which uses a finite control set model predictive control method to control an LLCL filter-based energy storage converter, establishes a state space mathematical model of the LLCL-based battery energy storage converter and discretizes it to obtain a discrete model. At the same time, based on a phasor method, reference values of a current at a grid side are converted into reference values of a current at a converter side and reference values of capacitor voltage. A cost function is defined, output results of a prediction model are compared with the reference values, and an optimal voltage vector and a most appropriate switching state are selected for operating.

The energy storage converter used in this embodiment is a typical two-level voltage source battery energy storage converter.

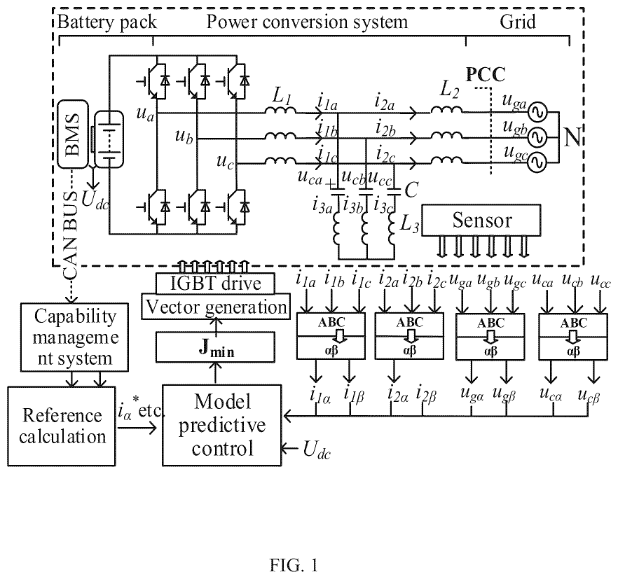

As shown in FIG. 1, FIG. 1 is an overall control block diagram of a system corresponding to the present disclosure. A finite control set model predictive control method of an LLCL battery energy storage converter is executed on the system, and includes the following steps.

In step 1, electrical physical quantities are collected by using sensors, a current at a grid side, a current at a converter side, a grid voltage and a capacitor voltage at current time are acquired, and a state space mathematical model of an LLCL filter is built based on the collected electrical physical quantities. In this embodiment, the capacitor voltage refers to a filter capacitor voltage.

The specific steps are as follows.

A two-phase stationary coordinate system, that is, an α-β coordinate system is established, and the state space mathematical model of an LLCL filter is derived in the α-β coordinate system.

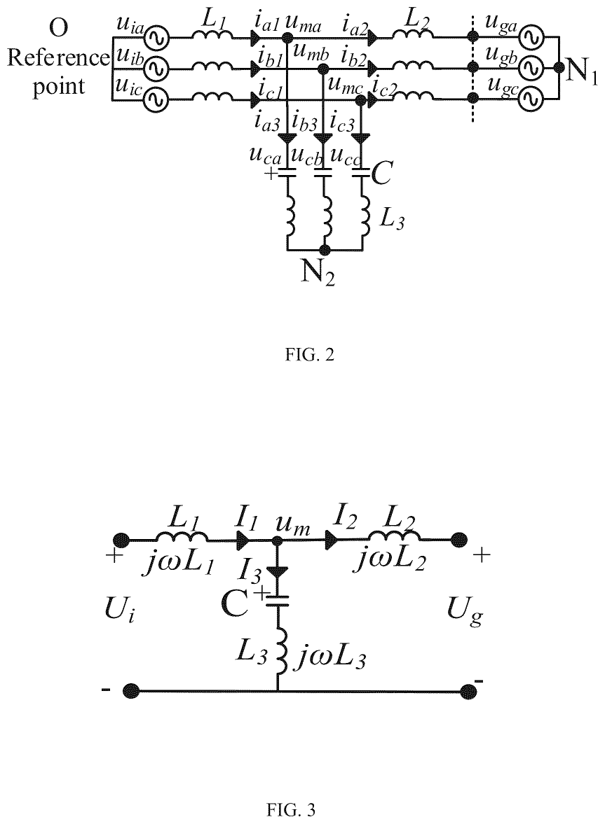

As shown in FIG. 2, FIG. 2 is a schematic diagram of variable definitions of an LLCL energy storage converter.

Current i₁ flowing through an inductor L₁, a current i₂ flowing through an inductor L₂ and a voltage u_{c} of a capacitor C are state space variables. Based on an overall topological structure of the battery energy storage converter, basic equations of each loop under an α coordinate axis are established:

$${L}_{1} \frac{{di}_{1 α}}{dt} = {u}_{i α} - {u}_{m α} \qquad ( 1 )$$

$${L}_{2} \frac{{di}_{2 α}}{dt} = {u}_{m α} - {u}_{g α} \qquad ( 2 )$$

$${i}_{3 α} = {i}_{1 α} - {i}_{2 α} \qquad ( 3 )$$

$${u}_{m α} = {u}_{c α} + {L}_{3} \frac{{di}_{3 α}}{dt} \qquad ( 4 )$$

$$C \frac{{du}_{c α}}{dt} = {i}_{1} - {i}_{2} \qquad ( 5 )$$

where for the α coordinate axis, i_{1α} is an instantaneous value of the current at the converter side, i_{2α} is a value of the current at the grid side, i_{3α} is a value of the current flowing through the capacitor, u_{iα} is a converter output voltage, u_{mα} is a value of a voltage at a coupling point of an LC branch, u_{gα} is a value of the voltage at the grid side, u_{cα} is a value of capacitor voltage, C is a capacitor value, L₁ is a first inductance value, and L₂ is a second inductance value.

By substituting equations (3) and (4) into equations (1) and (2), and by variable substitution, the equations of an α component are derived as shown in equation (6):

$$\{ \begin{matrix}\begin{matrix}\frac{{di}_{1 α}}{dt} = \frac{{L}_{2} + {L}_{3}}{{L}_{1} {L}_{2} + {L}_{1} {L}_{3} + {L}_{2} {L}_{3}} {u}_{i α} - \frac{{L}_{2}}{{L}_{1} {L}_{2} + {L}_{1} {L}_{3} + {L}_{2} {L}_{3}} {u}_{c α} - \\ \frac{{L}_{3}}{{L}_{1} {L}_{2} + {L}_{1} {L}_{3} + {L}_{2} {L}_{3}} {u}_{g α}\end{matrix} \\ \begin{matrix}\frac{{di}_{1 α}}{dt} = \frac{{L}_{3}}{{L}_{1} {L}_{2} + {L}_{1} {L}_{3} + {L}_{2} {L}_{3}} {u}_{i α} + \frac{{L}_{1}}{{L}_{1} {L}_{2} + {L}_{1} {L}_{3} + {L}_{2} {L}_{3}} {u}_{c α} - \\ \frac{{L}_{1} + {L}_{3}}{{L}_{1} {L}_{2} + {L}_{1} {L}_{3} + {L}_{2} {L}_{3}} {u}_{g α}\end{matrix} \\ \frac{{du}_{c α}}{dt} = \frac{1}{C} ( {i}_{1 α} - {i}_{2 α} )\end{matrix} \qquad ( 6 )$$

where L₃ is a third inductance value.

Further, because an α axis and an β axis of the α-β coordinate system are completely symmetric, the state space mathematical model of the LLCL filter on the β axis can be obtained by replacing α with β, and the state space variables of i₁, i₂ and u_{c} can be obtained simultaneously, that is, the state space mathematical model of the LLCL filter on the α-β coordinate system is obtained as follows:

$$\{ \begin{matrix}\frac{{dx}_{α}}{dt} = {Ax}_{α} + {Bu}_{i α} + {B}_{g} {u}_{g α} \\ \frac{{dx}_{β}}{dt} = {Ax}_{β} + {Bu}_{i β} + {B}_{g} {u}_{g β}\end{matrix} \qquad ( 7 )$$

where x_{α}=[i_{1α} i_{2α} u_{cα]}^{T} is a state space vector on the α axis, x_{β}=[i_{1β} i_{2β} u_{cβ]}^{T} is a state space vector on the β axis, and expressions of matrix A, matrix B and matrix B_{g} are as follows, respectively:

$$A = [ \begin{matrix}0 & 0 & - {L}_{2} / {L}_{\sum } \\ 0 & 0 & {L}_{1} / {L}_{\sum } \\ 1 / C & - 1 / C & 0\end{matrix} ]$$

$$B = {[ \begin{matrix}( {L}_{2} + {L}_{3} ) / {L}_{\sum } & {L}_{3} / {L}_{\sum } & 0\end{matrix} ]}^{T}$$

$${B}_{g} = {[ \begin{matrix}- {L}_{3} / {L}_{\sum } & - ( {L}_{1} + {L}_{3} ) / {L}_{\sum } & 0\end{matrix} ]}^{T}$$

where L_{Σ}=L₁L₂+L₁L₃+L₂L₃.

In step 2, a sampling period is set, that is, the battery energy storage switching period is set as Tₛ, the state space mathematical model (7) of the LLCL filter is discretized by using a zero-order holder method, and an expression of the discrete model of the LLCL filter is obtained as follows:

$$\{ \begin{matrix}{x}_{α} ( k + 1 ) = {A}_{d} {x}_{α} ( k ) + {B}_{d} {u}_{i α} ( k ) + {B}_{gd} {u}_{g α} ( k ) \\ {x}_{β} ( k + 1 ) = {A}_{d} {x}_{β} ( k ) + {B}_{d} {u}_{i β} ( k ) + {B}_{gd} {u}_{g β} ( k )\end{matrix} \qquad ( 8 )$$

where k indicates periodic time, detailed expressions of a system matrix A_{d} and input matrices B_{d} and B_{gd} are as follows:

$$( 9 )$$

$${A}_{d} = {e}^{{AT}_{s}} = [ \begin{matrix}\frac{{L}_{1} + {L}_{2} cos ( {ω}_{res} {T}_{s} )}{{L}_{1} + {L}_{2}} & \frac{{L}_{2} ( 1 - cos ( {ω}_{res} {T}_{s} ) )}{{L}_{1} + {L}_{2}} & - \frac{{L}_{2} sin ( {ω}_{res} {T}_{s} )}{{ω}_{res} {L}_{\sum }} \\ \frac{{L}_{1} ( 1 - cos ( {ω}_{res} {T}_{s} ) )}{{L}_{1} + {L}_{2}} & \frac{{L}_{2} + {L}_{1} cos ( {ω}_{res} {T}_{s} )}{{L}_{1} + {L}_{2}} & \frac{{L}_{1} sin ( {ω}_{res} {T}_{s} )}{{ω}_{res} {L}_{\sum }} \\ \frac{sin ( {ω}_{res} {T}_{s} )}{{ω}_{res} C} & - \frac{sin ( {ω}_{res} {T}_{s} )}{{ω}_{res} C} & cos ( {ω}_{res} {T}_{s} )\end{matrix} ]$$

$${B}_{d} = {\int }_{0}^{{T}_{s}} {e}^{A τ} Bd τ = [ \begin{matrix}\frac{{T}_{s}}{{L}_{1} + {L}_{2}} + \frac{{L}_{2}^{2} sin ( {ω}_{res} {T}_{s} )}{{L}_{\sum } ( {L}_{1} + {L}_{2} ) {ω}_{res}} \\ \frac{{T}_{s}}{{L}_{1} + {L}_{2}} - \frac{{L}_{1} {L}_{2} sin ( {ω}_{res} {T}_{s} )}{{L}_{\sum } ( {L}_{1} + {L}_{2} ) {ω}_{res}} \\ \frac{{L}_{2} ( 1 - cos ( {ω}_{res} {T}_{s} ) )}{( {L}_{1} + {L}_{2} )}\end{matrix} ] \qquad ( 10 )$$

$${B}_{gd} = {\int }_{0}^{{T}_{s}} {e}^{A τ} {B}_{g} d τ = [ \begin{matrix}- \frac{{T}_{s}}{{L}_{1} + {L}_{2}} + \frac{{L}_{1} {L}_{2} sin ( {ω}_{res} {T}_{s} )}{{L}_{\sum } ( {L}_{1} + {L}_{2} ) {ω}_{res}} \\ - \frac{{T}_{s}}{{L}_{1} + {L}_{2}} - \frac{{L}_{1}^{2} sin ( {ω}_{res} {T}_{s} )}{{L}_{\sum } ( {L}_{1} + {L}_{2} ) {ω}_{res}} \\ \frac{{L}_{1} ( 1 - cos ( {ω}_{res} {T}_{s} ) )}{( {L}_{1} + {L}_{2} )}\end{matrix} ] \qquad ( 11 )$$

where ωᵣₑₛ is an equivalent resonant angular frequency of the LLCL filter, and its expression is as follows:

$${ω}_{res} = \sqrt{\frac{{L}_{1} + {L}_{2}}{{L}_{\sum } C}} . \qquad ( 12 )$$

In step 3, based on the phasor method, reference values of capacitor voltage and current at the converter side at the current time, that is, in the k-th sampling period, are derived by using given values i_{2α}*(k) and i_{2β}*(k) of the current at the grid side in the k-th sampling period. A simplification process includes the following steps.

First, a simplified circuit of an LLCL filter is shown in FIG. 3, where Uᵢ indicates input voltage, U_{g} indicates output voltage, ω is an angular frequency of the grid, I₁ is a current value flowing through inductor L₁, I₂ is a current value flowing through inductor L₂, and I₃ is a current value flowing through capacitor C, which are defined as:

$${\dot{U}}_{i} = {U}_{i} ∠0° , \qquad ( 13 )$$

$${\dot{I}}_{1} = {I}_{1} ∠0° ,$$

$${\dot{I}}_{2} = {I}_{2} ∠0° ,$$

$${\dot{U}}_{g} = {U}_{g} ∠0°$$

Secondly, according to Kirchhoff Voltage Law (KVL) and Kirchhoff Current Law (KCL), the expressions of the voltage value Uₘ at the common coupling point and the current value I₁ flowing through the inductor L₁ are as shown in equation (14) and equation (15):

$${\dot{U}}_{m} = {\dot{U}}_{g} + j ω {L}_{2} {\dot{I}}_{2} \qquad ( 14 )$$

$${\dot{I}}_{1} = {\dot{I}}_{2} + {\dot{I}}_{3} \qquad ( 15 )$$

The expression of the filter capacitor voltage U_{c} is as follows:

$${\dot{U}}_{c} = \frac{1}{1 - {ω}^{2} {L}_{3} C} ( {\dot{U}}_{g} + j ω {L}_{2} {\dot{I}}_{2} ) \qquad ( 16 )$$

$$where :$$

$${\dot{I}}_{3} = \frac{j ω C}{1 - {ω}^{2} {L}_{3} C} {\dot{U}}_{m} \qquad ( 17 )$$

Finally, the equation (17) is substituted into the equation (15). According to the basic quantity relationship between each phasor in steady state and in the α-β coordinate system, the reference values of the current at the converter side and filter capacitor voltage at time k can be derived as follows:

$$[ \begin{matrix}{u}_{c α}^{*} ( k ) \\ {u}_{c β}^{*} ( k )\end{matrix} ] = \frac{1}{1 - {ω}^{2} {L}_{3} C} ( [ \begin{matrix}{u}_{g α} ( k ) \\ {u}_{g β} ( k )\end{matrix} ] + ω {L}_{2} [ \begin{matrix}- {i}_{2 α}^{*} ( k ) \\ {i}_{2 β}^{*} ( k )\end{matrix} ] ) \qquad ( 18 )$$

$$[ \begin{matrix}{i}_{1 α}^{*} ( k ) \\ {i}_{1 β}^{*} ( k )\end{matrix} ] = ( 1 - \frac{{ω}^{2} {L}_{3} C}{1 - {ω}^{2} {L}_{3} C} ) [ \begin{matrix}{i}_{2 α}^{*} ( k ) \\ {i}_{2 β}^{*} ( k )\end{matrix} ] \qquad ( 19 )$$

Reference values of the capacitor voltage are u_{cα}*(k) and u_{cβ}*(k), and reference values of the current at the converter side are i_{α1}*(k) and i_{β1}*(k).

According to the above derivation results, the problem that the reference value of the current and the reference value of filter capacitor voltage of the converter cannot be given directly at the current time can be solved.

After a reference value of the LLCL filter at time k is obtained, the reference value at time k+1 is obtained, and an optimal output voltage vector that minimizes a result of the cost function is selected. The present disclosure uses the Lagrange n-order extrapolation method to predict the reference values of the reference variables at t time k+1 based on the reference values of the current at the converter side and capacitor voltage in a k-th sampling period.

The equation for predicting a future value of reference variables by a Lagrange n-order extrapolation method is shown in equation (20):

$${x}^{*} ( k + 1 ) = {\sum }_{l = 0}^{n} {( - 1 )}^{n - 1} \frac{( n + 1 ) !}{l ! ( n + 1 - l ) !} {x}^{*} ( k + l - n ) \qquad ( 20 )$$

For a sinusoidal reference value involved in the battery energy storage converter, when n=2 is selected, the reference value expression at time k+1 is obtained as shown in equation (21):

$$\{ \begin{matrix}{i}_{1 α}^{*} ( k + 1 ) = 3 {i}_{1 α}^{*} ( k ) - 3 {i}_{1 α}^{*} ( k - 1 ) + {i}_{1 a}^{*} ( k - 2 ) \\ {i}_{1 β}^{*} ( k + 1 ) = 3 {i}_{1 β}^{*} ( k ) - 3 {i}_{1 β}^{*} ( k - 1 ) + {i}_{1 β}^{*} ( k - 2 ) \\ {i}_{2 α}^{*} ( k + 1 ) = 3 {i}_{2 α}^{*} ( k ) - 3 {i}_{2 α}^{*} ( k - 1 ) + {i}_{2 α}^{*} ( k - 2 ) \\ {i}_{2 β}^{*} ( k + 1 ) = 3 {i}_{2 β}^{*} ( k ) - 3 {i}_{2 β}^{*} ( k - 1 ) + {i}_{2 β}^{*} ( k - 2 ) \\ {u}_{c α}^{*} ( k + 1 ) = 3 {u}_{c α}^{*} ( k ) - 3 {u}_{c α}^{*} ( k - 1 ) + {u}_{c α}^{*} ( k - 2 ) \\ {u}_{c β}^{*} ( k + 1 ) = 3 {u}_{c β}^{*} ( k ) - 3 {u}_{c β}^{*} ( k - 1 ) + {u}_{c β}^{*} ( k - 2 )\end{matrix} \qquad ( 21 )$$

where i_{1α}*(k+1) and i_{1β}*(k+1) indicate reference values of the current at the converter side at time k+1, i_{2α}*(k+1) and i_{2β}*(k+1) indicate reference values of the current at the grid side at time k+1, u_{cα}*(k+1) and u_{cβ}*(k+1) indicate reference values of capacitor voltage at time k+1. set.

In order to achieve the objective of model predictive control, after the predicted value of the reference variable is obtained, a cost function should be defined to quantitatively evaluate the control performance of each vector in the finite control set. Therefore, building the cost function is an important issue in FCS-MPC. In this embodiment, the cost function J is defined as:

$$J = {ε}_{i 1}^{2} ( k + 1 ) + {λ}_{i 2} {ε}_{i 2}^{2} ( k + 1 ) + {λ}_{uc} {ε}_{uc}^{2} ( k + 1 ) \qquad ( 22 )$$

where λᵢ₂ and λ_{uc}, indicate priorities of modulation weight factor control, εᵢ₁ indicates an error between a reference value and a predicted value of the current at the converter side at next time, εᵢ₂ indicates an error between a reference value and a predicted value of the current at the grid side at next time, and ε_{uc} indicates an error between a reference value and a predicted value of capacitor voltage at next time. The expressions are shown in equation (23):

$$\{ \begin{matrix}{ε}_{i 1}^{2} ( k + 1 ) = {( {i}_{1 α}^{*} ( k + 1 ) - {i}_{1 α} ( k + 1 ) )}^{2} + {( {i}_{1 β}^{*} ( k + 1 ) - {i}_{1 β} ( k + 1 ) )}^{2} \\ {ε}_{i 2}^{2} ( k + 1 ) = {( {i}_{2 α}^{*} ( k + 1 ) - {i}_{2 α} ( k + 1 ) )}^{2} + {( {i}_{2 β}^{*} ( k + 1 ) - {i}_{2 β} ( k + 1 ) )}^{2} \\ {ε}_{u c}^{2} ( k + 1 ) = {( {u}_{u α}^{*} ( k + 1 ) - {u}_{c α} ( k + 1 ) )}^{2} + {( {u}_{c β}^{*} ( k + 1 ) - {u}_{c β} ( k + 1 ) )}^{2}\end{matrix} \qquad ( 23 )$$

where i_{1α}*(k+1) and i_{1β}*(k+1) indicate reference values of the current at the converter side at time k+1, i_{2α}*(k+1) and i_{2β}*(k+1) indicate reference values of the current at the grid side time k+1, u_{cα}*(k+1) and u_{cβ}*(k+1) indicate reference values of capacitor voltage at time k+1; i_{1α} (k+1) and i_{1β} (k+1) indicate predicted values of the current at the converter side at time k+1, i_{2α} (k+1) and i_{2β} (k+1) indicate predicted values of the current at the grid side at time k+1, and u_{cα} (k+1) and u_{cβ} (k+1) indicate predicted values of capacitor voltage at time k+1.

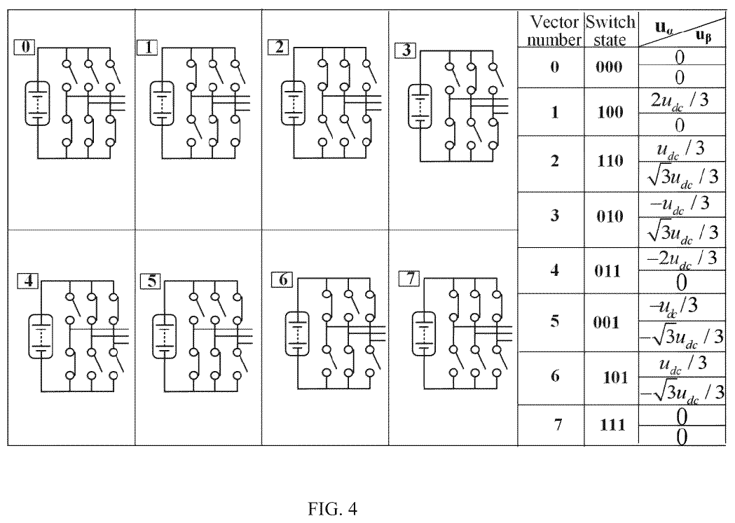

As shown in FIG. 4, the control set of the battery energy storage converter includes eight voltage vectors, numbered 0-7, respectively, and each voltage vector has a corresponding circuit switch state. The corresponding relationships among vector numbers, switch states and voltage vectors are shown in Table 1.

TABLE 1

| Vector | switch | u_{α} |
|---|---|---|
| number | state | u_{β} |
| 0 | 000 | 0 |
| | | 0 |
| 1 | 100 | 2U_{dc}/3 |
| | | 0 |
| 2 | 110 | U_{dc}/3 |
| | | \sqrt{3}U_{dc}/3 |
| 3 | 010 | −U_{dc}/3 |
| | | \sqrt{3}U_{dc}/3 |
| 4 | 011 | −2U_{dc}/3 |
| | | 0 |
| 5 | 001 | −U_{dc}/3 |
| | | −\sqrt{3}U_{dc}/3 |
| 6 | 101 | U_{dc}/3 |
| | | −\sqrt{3}U_{dc}/3 |
| 7 | 111 | 0 |
| | | 0 |

After the cost function j is defined, based on the reference value at time k+1, a cost function corresponding to each voltage vector is calculated, and an optimal output voltage vector that minimizes a result of the cost function is selected. The elements in the control set shown in FIG. 4 are substituted into the prediction model, respectively. The details are as follows.

The cost function expressions corresponding to the voltage vectors numbered 0-7 in the finite set are defined as J₀-J₇. First, J₁ and J₄ are calculated. It is assumed that [u_{α}(k) u_{β}(k)]^{T}=U_{dc}×[⅔ 0]^{T}, which is substituted into equation (8) to obtain a predicted value of the reference value at time k+1. The predicted value is substituted into equation (22) to obtain a calculation result J₁ of the cost function, where U_{dc} represents voltage of the DC-side battery (which can be considered as a constant).

Then, it is assumed that [u_{α}(k) u_{β}(k)]^{T}=U_{dc}×[−⅔ 0]^{T}, which is substituted into equation (8) to obtain a predicted value in the same step as above. Then, the predicted value is substituted into equation (22) to obtain the result J₄.

First, J₁ and J₄ are calculated. If J₁<J₄, J₀, J₂ and J₆ are further calculated, and J₀, J₂, J₆ and J₁ are compared. The voltage vector that minimizes a result of the cost function is selected as an optimal vector. At this time, vectors 3, 4 and 5 in the control set are excluded.

If J₁>J₄, J₀, J₃ and J₅ are further calculated, and J₀, J₃, J₅ and J₄ are compared. At this time, vectors 1, 2 and 6 in the control set are excluded. The voltage vector that minimizes a result of the cost function is selected as an optimal vector.

If the subscript corresponding to the calculated minimum J is 0, an optimal vector is selected between vector 0 and vector 7 according to the principle of minimum number of switches.

Finally, according to the corresponding relationship between the voltage vector and the circuit switch tube, the optimal output voltage vector is sent to control the appropriate circuit switch state to operate. For example, vector 1 (100) represents that an upper tube of phase A is on, a lower tube of phase B is on, and a lower tube of phase C is on, and so on.

Generally, FCS-MPC is designed to select the most suitable switching state to operate from the complete control set as shown in FIG. 4. According to the implementation steps described in this embodiment, the LLCL grid-connected converter can operate stably with the support of the finite control set model predictive control algorithm.

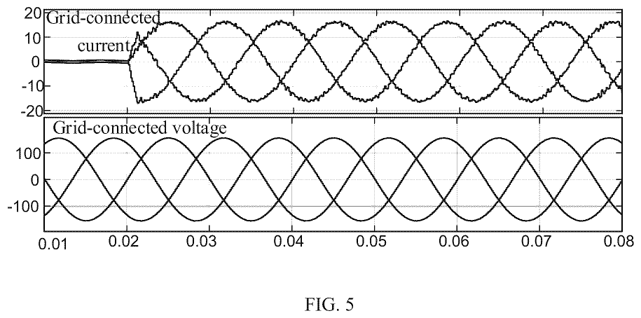

In order to verify the control algorithm, the embodiment uses the simulation model to verify, and the waveforms of the grid-connected current and the grid-connected voltage are obtained as shown in FIG. 5, which shows that the grid-connected converter based on the control of the present disclosure operates normally and can meet the grid-connected requirements.

Although the present disclosure has been described in detail with general descriptions and specific embodiments, it is apparent to those skilled in the art that some modifications or improvements can be made on the basis of the present disclosure. Therefore, these modifications or improvements made without departing from the spirit of the present disclosure fall within the scope of protection of the present disclosure.

1. A finite control set model predictive control method of an LLCL battery energy storage converter, comprising:
collecting electrical physical quantities by using sensors, wherein the electrical physical quantities comprise a current at a grid side, a current at a converter side, a grid voltage and a capacitor voltage at a current time;
building a state space mathematical model of an LLCL filter based on the electrical physical quantities;
setting a sampling period and discretizing the state space mathematical model of the LLCL filter to obtain a discrete model;
deriving reference values of the current at the converter side and reference values of the capacitor voltage in a k-th sampling period by using a given value of the current at the grid side in the k-th sampling period;
based on the reference values of the current at the converter side and the reference values of the capacitor voltage in the k-th sampling period, predicting reference values at time k+1 according to the discrete model;
defining a cost function to quantitatively evaluate control performance of each voltage vector in a finite set;
calculating the cost function corresponding to each voltage vector based on the reference values at time k+1, and selecting an optimal output voltage vector which minimizes a result of the cost function;
based on a corresponding relationship between each voltage vector and a circuit switch, sending the optimal output voltage vector to control an appropriate circuit switch state for operating.

2. The method according to claim 1, wherein building the state space mathematical model of the LLCL filter comprises:
establishing a two-phase stationary coordinate system which is an α-β coordinate system;
with current i₁ flowing through an inductor L₁, current i₂ flowing through an inductor L₂ and a voltage u_{c} of a capacitor C as state space variables, based on an overall topological structure of the battery energy storage converter, establishing basic equations of each loop under an α coordinate axis:
$${L}_{1} \frac{{di}_{1 α}}{dt} = {u}_{i α} - {u}_{m α} \qquad ( 1 )$$
$${L}_{2} \frac{{di}_{2 a}}{dt} = {u}_{m α} - {u}_{g α} \qquad ( 2 )$$
$${i}_{3 α} = {i}_{1 α} - {i}_{2 α} \qquad ( 3 )$$
$${u}_{m α} = {u}_{c α} + {L}_{3} \frac{{di}_{3 α}}{dt} \qquad ( 4 )$$
$$C \frac{{du}_{c α}}{dt} = {i}_{1} - {i}_{2} \qquad ( 5 )$$
wherein for the α coordinate axis, i_{1α} is an instantaneous value of the current at the converter side, i_{2α} is a value of the current at the grid side, i_{3α} is a value of the current flowing through the capacitor, u_{iα} is a converter output voltage, u_{mα} is a value of the voltage at a coupling point of an LC branch, u_{gα} is a value of the voltage at the grid side, u_{cα} is a value of the capacitor voltage, C is a capacitor value, L₁ is a first inductance value, and L₂ is a second inductance value;
deriving equations of an α component as shown in equation (6) by substituting equations (3) and (4) into equations (1) and (2) and by variable substitution:
$$\{ \begin{matrix}\frac{{di}_{1 α}}{dt} = \frac{{L}_{2} + {L}_{3}}{{L}_{1} {L}_{2} + {L}_{1} {L}_{3} + {L}_{2} {L}_{3}} {u}_{i α} - \frac{{L}_{2}}{{L}_{1} {L}_{2} + {L}_{1} {L}_{3} + {L}_{2} {L}_{3}} {u}_{c α} - \frac{{L}_{3}}{{L}_{1} {L}_{2} + {L}_{1} {L}_{3} + {L}_{2} {L}_{3}} {u}_{g α} \\ \frac{{di}_{2 α}}{dt} = \frac{{L}_{3}}{{L}_{1} {L}_{2} + {L}_{1} {L}_{3} + {L}_{2} {L}_{3}} {u}_{i α} + \frac{{L}_{1}}{{L}_{1} {L}_{2} + {L}_{1} {L}_{3} + {L}_{2} {L}_{3}} {u}_{c α} - \frac{{L}_{1} + {L}_{3}}{{L}_{1} {L}_{2} + {L}_{1} {L}_{3} + {L}_{2} {L}_{3}} {u}_{g α} \\ \frac{{du}_{c α}}{dt} = \frac{1}{C} ( {i}_{1 α} - {i}_{2 α} )\end{matrix} \qquad ( 6 )$$
wherein L₃ is a third inductance value;
obtaining an expression of the state space mathematical model of the LLCL filter on the α axis:
$$\frac{{dx}_{α}}{dt} = {Ax}_{α} + {Bu}_{i α} + {B}_{g} {u}_{g α} ;$$
wherein x_{α}=[i_{1α} i_{2α} u_{cα}]^{T} is a state space vector on the α axis, and expressions of matrix A, matrix B and matrix B_{g} are respectively:
$$A = [ \begin{matrix}0 & 0 & - {L}_{2} / {L}_{\sum } \\ 0 & 0 & {L}_{1} / {L}_{\sum } \\ 1 / C & - 1 / C & 0\end{matrix} ]$$
$$B = {[ \begin{matrix}( {L}_{2} + {L}_{3} ) / {L}_{\sum } & {L}_{3} / {L}_{\sum } & 0\end{matrix} ]}^{T}$$
$${B}_{g} = {[ \begin{matrix}- {L}_{3} / {L}_{\sum } & - ( {L}_{1} + {L}_{3} ) / {L}_{\sum } & 0\end{matrix} ]}^{T}$$
wherein L_{Σ}=L₁L₂+L₁L₃+L₂L₃.

3. The method according to claim 2, wherein the α axis and the β axis of the α-β coordinate system are symmetric, and an expression of the state space mathematical model of the LLCL filter on the β axis is obtained by replacing α with β:
$$\frac{{dx}_{β}}{dt} = {Ax}_{β} + {Bu}_{i β} + {B}_{g} {u}_{g β} ;$$
wherein x_{β}=[i_{1β} i_{2β} u_{cβ}]^{T} is an state space vector on the β axis, and for the β coordinate axis, i_{1β} is an instantaneous value of the current at the converter side, i_{2β} is a value of the current at the grid side, u_{1β} is a converter output voltage, u_{gβ} is a value of the voltage at the grid side, and u_{cβ} is a value of the capacitor voltage; and
the state space mathematical model of the LLCL filter in the α-β coordinate system is obtained:
$$\{ \begin{matrix}\frac{{dx}_{α}}{dt} = {Ax}_{α} + {Bu}_{i α} + {B}_{g} {u}_{g α} \\ \frac{{dx}_{β}}{dt} = {Ax}_{β} + {Bu}_{i β} + {B}_{g} {u}_{g β}\end{matrix} \qquad ( 7 )$$

4. The method according to claim 3, wherein the sampling period is a battery energy storage switching period, the sampling period is set as Tₛ, the expression (7) of the state space mathematical model of the LLCL filter is discretized by using a zero-order holder method, and an expression of the discrete model of the LLCL filter is obtained:
$$\{ \begin{matrix}{x}_{α} ( k + 1 ) = {A}_{d} {x}_{α} ( k ) + {B}_{d} {u}_{i α} ( k ) + {B}_{g d} {u}_{g α} ( k ) \\ {x}_{β} ( k + 1 ) = {A}_{d} {x}_{β} ( k ) + {B}_{d} {u}_{i β} ( k ) + {B}_{g d} {u}_{g β} ( k )\end{matrix} \qquad ( 8 )$$
wherein k indicates a periodic time, and detailed expressions of a system matrix A_{d} and input matrices B_{d} and B_{gd} are:
$${A}_{d} = {e}^{{AT}_{s}} = [ \begin{matrix}\frac{{L}_{1} + {L}_{2} cos ( {ω}_{res} {T}_{s} )}{{L}_{1} + {L}_{2}} & \frac{{L}_{2} ( 1 - cos ( {ω}_{res} {T}_{s} ) )}{{L}_{1} + {L}_{2}} & - \frac{{L}_{2} sin ( {ω}_{res} {T}_{s} )}{{ω}_{res} {L}_{\sum }} \\ \frac{{L}_{1} ( 1 - cos ( {ω}_{res} {T}_{s} ) )}{{L}_{1} + {L}_{2}} & \frac{{L}_{2} + {L}_{1} cos ( {ω}_{res} {T}_{s} )}{{L}_{1} + {L}_{2}} & \frac{{L}_{1} sin ( {ω}_{res} {T}_{s} )}{{ω}_{res} {L}_{\sum }} \\ \frac{sin ( {ω}_{res} {T}_{s} )}{{ω}_{res} C} & - \frac{sin ( {ω}_{res} {T}_{s} )}{{ω}_{res} C} & cos ( {ω}_{res} {T}_{s} )\end{matrix} ] \qquad ( 9 )$$
$${B}_{d} = {\int }_{0}^{{T}_{s}} {e}^{A τ} Bd τ = [ \begin{matrix}\frac{{T}_{s}}{{L}_{1} + {L}_{2}} + \frac{{L}_{2}^{2} sin ( {ω}_{res} {T}_{s} )}{{L}_{\sum } ( {L}_{1} + {L}_{2} ) {ω}_{res}} \\ \frac{{T}_{s}}{{L}_{1} + {L}_{2}} + \frac{{L}_{1} {L}_{2} sin ( {ω}_{res} {T}_{s} )}{{L}_{\sum } ( {L}_{1} + {L}_{2} ) {ω}_{res}} \\ \frac{{L}_{2} ( 1 - cos ( {ω}_{res} {T}_{s} ) )}{( {L}_{1} + {L}_{2} )}\end{matrix} ] \qquad ( 10 )$$
$${B}_{gd} = {\int }_{0}^{{T}_{s}} {e}^{A τ} {B}_{g} d τ = [ \begin{matrix}- \frac{{T}_{s}}{{L}_{1} + {L}_{2}} + \frac{{L}_{1} {L}_{2} sin ( {ω}_{res} {T}_{s} )}{{L}_{\sum } ( {L}_{1} + {L}_{2} ) {ω}_{res}} \\ - \frac{{T}_{s}}{{L}_{1} + {L}_{2}} + \frac{{L}_{1}^{2} sin ( {ω}_{res} {T}_{s} )}{{L}_{\sum } ( {L}_{1} + {L}_{2} ) {ω}_{res}} \\ \frac{{L}_{1} ( 1 - cos ( {ω}_{res} {T}_{s} ) )}{( {L}_{1} + {L}_{2} )}\end{matrix} ] \qquad ( 11 )$$
wherein ωᵣₑₛ is an equivalent resonant angular frequency of the LLCL filter, and an expression thereof is:
$${ω}_{res} = \sqrt{\frac{{L}_{1} + {L}_{2}}{{L}_{\sum } C}} . \qquad ( 12 )$$

5. The method according to claim 2, wherein based on a phasor method, deriving the reference values i_{α1}*(k) and i_{β1}*(k) of the current at the converter side and the reference values u_{cα}*(k) and u_{cβ}*(k) of the capacitor voltage in the k-th sampling period by using the given values i_{2α}*(k) and i_{cβ}*(k) of the current at the grid side in the k-th sampling period, which are respectively expressed as;
$$[ \begin{matrix}{u}_{c α}^{*} ( k ) \\ {u}_{c β}^{*} ( k )\end{matrix} ] = \frac{1}{1 - {ω}^{2} {L}_{3} C} ( [ \begin{matrix}{u}_{g α} ( k ) \\ {u}_{g β} ( k )\end{matrix} ] + ω {L}_{2} [ \begin{matrix}- {i}_{2 α}^{*} ( k ) \\ {i}_{2 β}^{*} ( k )\end{matrix} ] )$$
$$[ \begin{matrix}{i}_{1 α}^{*} ( k ) \\ {i}_{1 β}^{*} ( k )\end{matrix} ] = ( 1 - \frac{{ω}^{2} {L}_{2} C}{1 - {ω}^{2} {L}_{3} C} ) [ \begin{matrix}{i}_{2 α}^{*} ( k ) \\ {i}_{2 β}^{*} ( k )\end{matrix} ]$$
wherein ω is an angular frequency of the grid.

6. The method according to claim 5, wherein the reference values of the current at the grid side, the reference values of capacitor voltage and the reference values of the current at the converter side in the (k+1)-th sampling period are obtained based on a Lagrange n-order extrapolation method, and expressions thereof are:
$$\{ \begin{matrix}{i}_{1 α}^{*} ( k + 1 ) = 3 {i}_{1 α}^{*} ( k ) - 3 {i}_{1 α}^{*} ( k - 1 ) + {i}_{1 α}^{*} ( k - 2 ) \\ {i}_{1 β}^{*} ( k + 1 ) = 3 {i}_{1 β}^{*} ( k ) - 3 {i}_{1 β}^{*} ( k - 1 ) + {i}_{1 β}^{*} ( k - 2 ) \\ {i}_{2 α}^{*} ( k + 1 ) = 3 {i}_{2 α}^{*} ( k ) - 3 {i}_{2 α}^{*} ( k - 1 ) + {i}_{2 α}^{*} ( k - 2 ) \\ {i}_{2 β}^{*} ( k + 1 ) = 3 {i}_{2 β}^{*} ( k ) - 3 {i}_{2 β}^{*} ( k - 1 ) + {i}_{2 β}^{*} ( k - 2 ) \\ {u}_{c α}^{*} ( k + 1 ) = 3 {u}_{c α}^{*} ( k ) - 3 {u}_{c α}^{*} ( k - 1 ) + {u}_{c α}^{*} ( k - 2 ) \\ {u}_{c β}^{*} ( k + 1 ) = 3 {u}_{c {β}^{*}} ( k ) - 3 {u}_{c β}^{*} ( k - 1 ) + {u}_{c β}^{*} ( k - 2 )\end{matrix}$$
wherein i_{1α}*(k+1) and i_{1β}*(k+1) indicate reference values of the current at the converter side at time k+1, i_{2α}*(k+1) and i_{2β}*(k+1) indicate reference values of the current at the grid side at time k+1, u_{cα}*(k+1) and u_{cβ}*(k+1) indicate reference values of the capacitor voltage at time k+1.

7. The method according to claim 4, wherein the cost function is defined as:
$$J = {ε}_{i 1}^{2} ( k + 1 ) + {λ}_{i 2} {ε}_{i 2}^{2} ( k + 1 ) + {λ}_{uc} {ε}_{uc}^{2} ( k + 1 )$$
wherein λᵢ₂ and λ_{uc} indicate priorities of modulation weight factor control, εᵢ₁ indicates an error between the reference value and the predicted value of the current at the converter side at a next time, εᵢ₂ indicates an error between the reference value and the predicted value of the current at the grid side at the next time, ε_{uc} indicates an error between the reference value and the predicted value of the capacitor voltage at the next time, and expressions thereof are:
$$\{ \begin{matrix}{ε}_{i 1}^{2} ( k + 1 ) = {( {i}_{1 α}^{*} ( k + 1 ) - {i}_{1 α} ( k + 1 ) )}^{2} + {( {i}_{1 β}^{*} ( k + 1 ) - {i}_{1 β} ( k + 1 ) )}^{2} \\ {ε}_{i 2}^{2} ( k + 1 ) = {( {i}_{2 α}^{*} ( k + 1 ) - {i}_{2 α} ( k + 1 ) )}^{2} + {( {i}_{2 β}^{*} ( k + 1 ) - {i}_{2 β} ( k + 1 ) )}^{2} \\ {ε}_{uc}^{2} ( k + 1 ) = {( {u}_{u α}^{*} ( k + 1 ) - {u}_{c α} ( k + 1 ) )}^{2} + {( {u}_{c β}^{*} ( k + 1 ) - {u}_{c β} ( k + 1 ) )}^{2}\end{matrix}$$
wherein i_{1α}*(k+1) and i_{1β}*(k+1) indicate reference values of the current at the converter side at time k+1, i_{2α}*(k+1) and i_{2β}*(k+1) indicate reference values of the current at the grid side at time k+1, u_{cα}*(k+1) and u_{cβ}*(k+1) indicate reference values of the capacitor voltage at time k+1; i_{1α} (k+1) and 1β (k+1) indicate predicted values of the current at the converter side at time k+1, i_{2α} (k+1) and i_{2β} (k+1) indicate predicted values of the current at the grid side at time k+1, and u_{cα} (k+1) and u_{cβ} (k+1) indicate predicted values of the capacitor voltage at time k+1.

8. The method according to claim 7, wherein voltage vectors u_{α} (k) and u_{β} (k) in the finite set of the battery energy storage converter are numbered 0-7, respectively, and the voltage vectors are substituted into the discrete model of the LLCL filter to obtain a predicted value at time k+1.

9. The method according to claim 8, wherein the predicted value at time k+1is substituted into the cost function to obtain a calculation result of the cost function corresponding to each voltage vector; expressions of the cost functions corresponding to the voltage vectors numbered 0-7 in the finite set are defined as J₀-J₇;
J₁ and J₄ are calculated, if J₁<J₄, J₀, J₂ and J₆ are further calculated, J₀, J₂, J₆ and J₁ are compared to select a voltage vector that minimizes a result of the cost function as an optimal vector;
if J₁>J₄, J₀, J₃ and J₅ are further calculated, J₀, J₃, J₅ and J₄ are compared to select a voltage vector that minimizes a result of the cost function as an optimal vector.

10. The method according to claim 9, wherein if J₀ is a minimum cost function, an optimal vector is selected between the voltage vector 0 and the voltage vector 7 according to a principle of minimum number of switches.
